(19) United States
(12) Patent Application Publication
(10) Pub. No.: US 2022/0162108 A1
(43) Pub. Date: May 26, 2022

(54) APPARATUS AND METHOD FOR PROVIDING PURIFIED WATER

(71) Applicant: VWS (UK) LIMITED, High Wycombe Buckinghamshire (GB)

(72) Inventors: Nigel EMERY, Monks Risborough Buckinghamshire (GB); Lee UNDERWOOD, High Wycombe Buckinghamshire (GB); Paul Matthew NGUI, Brentwood Greater London (GB)

(21) Appl. No.: 17/599,612

(22) PCT Filed: Mar. 27, 2020
(86) PCT No.: PCT/GB2020/050824

§ 371 Date: Sep. 29, 2021

(30) Foreign Application Priority Data
Apr. 3, 2019 (GB) 1904672.1

(51) Int. Cl. C02F 9/00; C02F 1/469; C02F 1/42; C02F 1/44; C02F 1/72

(52) U.S. Cl. CPC C02F 9/005; C02F 1/4691; C02F 1/42; C02F 2103/04; C02F 1/441; C02F 1/72; C02F 1/4695

(57) ABSTRACT

A water purification apparatus including a first water purification station for a first internal purified water stream. A valve selects either a first dispense purified water stream or a first continuing water stream or both. An internal reservoir receives the first continuing water stream to hold a volume of second purified water, and provides a second internal purified water stream. A second valve able dispenses the second dispense purified water stream. A second water purification station receives the second internal purified water and provides a third internal purified water stream. A third valve selects from the third internal purified water stream either a third dispense purified water stream, or a third continuing water stream, or both. A recirculation loop returns the third continuing water stream into the internal reservoir. A pump pumps the second internal purified water stream from the internal reservoir around the recirculation loop.

The present invention relates to apparatus for, and method of, providing purified water, in particular at least three different purities of purified water, as well as grey water, from a water purification apparatus that is small enough to be portable and moved around, particularly but not exclusively, a laboratory.

Water purification apparatus and units for use in laboratories and healthcare facilities are well known. Generally, they involve the reduction and/or removal of contaminants and impurities to very low levels. They typically contain a variety of technologies that remove particles, colloids, bacteria, ionic or ionisable species and organic substances and/or molecules to a specified purity.

There are many water quality standards published throughout the world with water purity requirements that are expressed, at least, by the resistivity of the water at a specific temperature, usually 25° C. such that requirements can be specified as, from most pure to least pure of 18.2 MΩ·cm, >18 MΩ·cm, >10 MΩ·cm, >5 MΩ·cm, >1 MΩ·cm or >0.05 MΩ·cm. Other specifications on the water purity may be defined by the water's level of organic, microbial or endotoxin content. The purest of these purity levels are often referred to as ‘ultra-pure’ or ‘ultra-purified’ water while the less pure are more generally referred to as ‘pure’ or ‘purified’ water.

Analysers in laboratories often carry out a sequence of analyses on samples and it is important that the purity of water is maintained at minimum standards during these analyses. Advanced analytical techniques such as ion chromatography, high performance liquid chromatography, inductively coupled plasma mass spectroscopy etc. require a quantity of high purity water with each analytical technique having its specific purity requirement.

Many analytical laboratories now require a variety of purified stream qualities. Typically in such laboratories, only relatively small volumes of the purest levels such as ultra-pure water are required. Equipment or processes may require an amount of intermediately purified water such as for rinsing of process streams or for the preparation of bulk reagents from concentrated standards, while a greater volume of water is required for more general duties in the laboratories, such as rinsing of glassware and containers. However, the water purity or quality for such purposes, whilst still needing some degree of purification compared with general water sources, need not be of the highest possible purity or of an ‘ultra-pure’ standard. The production of water at each subsequent level of purity has an impact on the lifetime of each of the variety of technologies used in the water purification system and as each technology is used its performance or its future performance may decrease.

To provide multiple levels of purity of water, separate water purification systems each dedicated to providing the appropriate quality for the specific application, could be provided, but with attendant cost. Alternatively, a single water purification unit could be used to provide a single purified water, but it must operate at the highest quality for the analytical techniques, making it wasteful and expensive to operate for the larger volumes of less purified water.

Research facilities often change the focus of their work and would like the water to be provided in different locations such as different laboratories or benches within the same laboratory at different times. It is therefore preferable for a water purification unit to be easily moveable between benches or laboratories such that it only requires connecting to mains electricity and mains water via a socket and a tap at each location.

It is an object of the present invention to provide a simple and more cost-effective method of providing multiple purities of water from a single water purification system that is easily movable between locations within a laboratory or facility.

Thus, according to one aspect of the present invention, there is provided a water purification apparatus able to provide at least three dispense purified water streams of different water purities from the water purification apparatus, comprising at least:

(i) a water inlet stream;
(ii) a first water purification station comprising one or more first water purification process units connected to the water inlet and able to provide a first internal purified water stream;
(iii) a first valve able to select from the first internal purified water stream either a first dispense purified water stream, or a first continuing water stream, or both;
(iv) an internal reservoir within the water purification apparatus adapted to receive the first continuing water stream through a water inlet, to hold a volume of second purified water, and to provide a second internal purified water stream,
(v) a second valve able to dispense a second dispense purified water stream from the water purification apparatus;
(vi) a second water purification station comprising one or more second water purification process units able to receive the second internal purified water as a second continuing water stream, and able to provide a third internal purified water stream;
(vii) a third valve able to select from the third internal purified water stream either a third dispense purified water stream, or a third continuing water stream, or both;
(viii) a recirculation loop able to return the third continuing water stream into the internal reservoir; and
(ix) a pump able to pump the second internal purified water stream from the internal reservoir around the recirculation loop.

Preferably, one or more of the first and/or second water purification process units in the first and second water purification stations include one or more of the following group comprising: an oxidiser, a deioniser. Such items are discussed in more detail herein.

Preferably, the one or more first water purification process units in the first water purification station include one or more of the following group comprising: a reverse osmosis unit, a capacitive deionisation unit. Such items are discussed in more detail herein.

Preferably, the one or more second water purification process units in the second water purification station includes one or more of the following group comprising: ion exchange resin, electrodeionisation. Such items are discussed in more detail herein.

Optionally the one or more second water purification process units in the second water purification station further includes one or more of the following group comprising: UV oxidation, ozonation, electrochemical oxidation, ultrasonic oxidation. Such items are discussed in more detail herein.

Optionally, at least one of or each of the first, second and third dispense purified water outlet streams is pressurised or pumped. Preferably the second valve is located after the pump such that the second dispense purified water stream is a pressurised flow.

Preferably, the third dispense purified water stream is of greater purity than the second dispense purified water stream. Optionally, the third dispense purified water stream is ultra-pure water of resistivity >15 MΩ·cm, more preferably >18 MΩ·cm.

Preferably, the second dispense purified water stream is of greater purity than the first dispense purified water stream. Optionally, the second dispense purified water stream has a resistivity of >1 MΩ·cm.

Preferably, the first dispense purified water stream is of greater purity than the inlet water stream. Optionally, the first dispense purified water stream has a resistivity of >0.05 MΩ·cm.

Operation of the water purification apparatus may be programmed or controlled by one or more control systems, typically using one or more microprocessors, preferably sited on one or more printed circuit boards (PCB), with subsequent operational control of valves and pump based on inputs from a user interface, such as a touchscreen and/or input buttons, and inputs from sensors, such as level sensors, water quality measurement devices and where fitted flow measurement devices, as defined by software and firmware in the microprocessor.

Optionally, the second dispense purified water stream is provided from the recirculation loop. Preferably, the second valve is able to select from the second internal purified water stream either the second dispense purified water, or the second continuing water stream, or both said streams.

Alternatively or additionally, the second dispense purified water stream is provided from the internal reservoir.

The skilled person recognises that the present invention is not intended to only provide continuous dispense purified water outlet streams over time, and that in each valve selecting from each respective internal purified water stream, either dispense purified water as an outlet stream, or a continuing water stream, or both, that there will still be some portion of each internal purified water stream becoming a continuing water stream over time to provide a flow into or back into the internal reservoir. That is, the present invention is able to a dispense purified water outlet stream from each internal purified water stream, and a continuing water stream continues to pass through the water purification apparatus when providing a dispense purified water outlet stream is not fully selected from the relevant valve. The normal mode of operation will be with continuing/recirculation, with intermittent times of dispense (of the or each dispense purified water outlet stream) mode.

The water purification apparatus may be constructed within a single housing containing at least the first and second water purification stations, the internal reservoir, a control system, and the pump: optionally all of the purification technologies, reservoir, pumps, valves and controls.

Optionally, the water purification apparatus further includes one or more water connections able to extend the third dispense purified water stream or the recirculation loop beyond or outside the housing.

Optionally, the water purification apparatus is portable by one person around a laboratory requiring connection to feedwater and electricity at any particular location.

Preferably, the water purification apparatus has a mass of <15 kg when the reservoir is empty of water.

Preferably the water purification apparatus has a mass of <22 kg when the reservoir is full of water.

Optionally the water purification system has connections to attach a remote dispense point or to extend the recirculation loop external to the housing such as to a piece of equipment requiring the purified water.

Preferably the water purification apparatus contains a first water quality measurement device to measure the water quality of the second purified water in the internal reservoir, a second water quality measurement device to measure the water quality of the third internal purified water stream, and a reservoir level sensor that can measure the amount of water in the internal reservoir.

Preferably the water purification apparatus contains means to indirectly calculate the water quality of the first internal purified water stream from the measurements of the first water quality measurement device and the reservoir level sensor.

Preferably one or both of the water quality measurement devices measure the conductivity of the relevant water stream.

Optionally, the water purification apparatus further comprises a grey water outlet stream from the first water purification station.

According to a second aspect of the present invention, there is provided a method of providing at least three dispense purified water streams, and optionally a grey water outlet stream, from a portable water purification apparatus, comprising at least the steps of:
(a) passing a water inlet stream through a first water purification station comprising one or more first water purification process units to provide a first internal purified water stream that is of higher purity than the water inlet stream,
(b) providing by selecting from the first internal purified water stream, either a first dispense purified water stream, or a first continuing water stream, or both;
(c) passing the first continuing water stream to an internal reservoir within the water purification apparatus through a water inlet, the internal reservoir holding a volume of second purified water, and providing a second internal purified water stream from the reservoir,
(d) providing by selecting, either from the reservoir or from the second internal purified water stream, a second dispense purified water stream, or a second continuing water stream, or both;
(e) passing the second continuing water stream to a second water purification station comprising one or more second water purification process units, and providing a third internal purified water stream that is of higher purity than the second continuing water stream;
(f) providing by selecting from the third internal purified water stream, either a third dispense purified water stream, or a third continuing water stream, or both;
(g) recirculating the third continuing water stream into the internal reservoir around a recirculation loop; and
(h) pumping the second internal purified water stream from the internal reservoir around the recirculation loop.

Optionally, the method further comprises calculating the purity of the purified first internal purified water stream by measuring the conductivity of the second internal purified water stream.

Thus, in one embodiment of the present invention, there is provided a method of providing a dispense purified water stream, from a water purification apparatus, comprising at least the steps of:

(a) passing a water inlet stream through a first water purification station comprising one or more first water purification process units to provide a first internal purified water stream that is of higher purity than the water inlet stream;
(b) passing the first internal purified water stream to an internal reservoir within the water purification apparatus through a water inlet, the internal reservoir holding a volume of second purified water, and providing a second internal purified water stream from the reservoir;
(c) passing the second internal purified water stream from the reservoir into a recirculation loop;
(d) measuring the conductivity of the second internal purified water stream in the reservoir, or in the recirculation loop, or both;
(e) passing the second internal purified water stream to a second water purification station comprising one or more second water purification process units, and providing a third internal purified water stream that is of higher purity than the second internal purified water stream;
(f) providing by selecting from the third internal purified water stream, either a dispense purified water outlet stream, or a recirculated water return stream, or both;
(g) passing the recirculated water return stream into the internal reservoir from the recirculation loop;
(h) calculating the purity of the first internal purified water stream using the measurement of the conductivity of the second internal purified water stream.

Optionally, the method further includes the step of measuring the conductivity of the third internal purified water stream.

Optionally, the method further includes the steps of:

while filling the internal reservoir by the first internal purified water stream, measuring the rate of fill of the internal reservoir, and using such rate of fill in calculating the purity of the first internal purified water stream.

Optionally, the method further includes the steps of:

measuring the rate of flow of water in the recirculation loop; and using the measurement in calculating the purity of the first internal purified water stream.

Optionally, the method further includes the step of:
measuring a time period between reaching a predetermined volume of second purified water in the internal reservoir from first continuing purified water stream entering the internal reservoir, and a predetermined conductivity value of the second internal purified water stream.

Optionally in such method, the predetermined volume of second purified water is when the internal reservoir is wholly or substantially full.

Optionally in such method, the predetermined conductivity method is a nominal value such as 0.5 μS/cm. 1 μS/cm, 2 μS/cm, etc.

Optionally, the method further includes the step of: measuring conductivity of the second internal purified water stream over time. Optionally, over time until the measurement of conductivity of the second internal purified water stream reaches a predetermined value such as listed above, optionally a relatively constant value or steady state.

Optionally, the measurement of the conductivity of the second internal purified water stream is carried out by a first conductivity measurement device.

Optionally, any measurement of the conductivity of the third internal purified water stream is carried out by a second conductivity measurement device.

Optionally, the method further includes varying the speed of the recirculation loop.

Optionally, the method of the present invention includes two or more of the above further steps, whose combined measurements can be used to calculate the purity of at least the second internal purified water stream, optionally the first internal purified water stream,

According to another aspect of the present invention, there is provided a water purification system able to provide at least three dispense purified water streams of different water purities from the water purification apparatus, using either the water purification apparatus as described herein, or the method of providing at least three dispense purified water streams as described herein, or both, and optionally including one or more of the embodiments as described herein.

Ions dissolved in water result in the water having a conductivity that is a used as a measure of its purity. Potable water typically has a conductivity of between 100 to 1000 μS/cm and varies depending on its source.

The skilled man is aware of the relationship between conductivity and resistivity, such that either one or both measurements can be made by a suitable measurer or meter. Thus, the term “conductivity value” as used herein relates to the measurement of the conductivity and/or resistivity of a water stream. The skilled man is also aware that conductivity and/or resistivity measurements or values are temperature dependent. Commonly, a temperature of 25° C. is used as a standard temperature when discussing and comparing conductivity and/or resistivity measurements, such that the conductivity of “pure” water is considered to be 0.055 μS/cm and the resistivity is considered to be 18.2 MΩ-cm, at 25° C.

As the water is purified its conductivity decreases and its resistivity correspondingly increases.

Other parameters may be of importance in the purified water, such as the total organic contamination (TOC) being less than 500 ppb, potentially <5 ppb, or having a bacterial contamination of less than 100 cfu/ml, potentially <1 cfu/ml.

According to one embodiment of the present invention, recirculation around the recirculation loop is wholly or substantially continuous. Such active use may be during a laboratory ‘working hours’, and as long as there is enough water in the internal reservoir. When the level in the reservoir is too low, as indicated for example by a level control, then the pump could be turned off to prevent wear on the pump.

When the method of the present invention is not continuously or regularly required, for example outside working or operational hours of a laboratory, the water purification system would typically only recycle water from the reservoir intermittently, say 5 minutes per hour. This would maintain a high level of purity in the reservoir while reducing wear on any electrical components such as the pump motor or oxidisers such as ultraviolet light devices, and hence increase their life.

The first water purification station preferably includes one process unit being a deioniser to purify the inlet or feed water to the first dispense purified water quality desired. Preferably the deioniser is a reverse osmosis unit or a capacitive deionisation unit. Operation of these units are known in the art and not described in detail herein. Waste ions can be passed from the first water purification station as a ‘grey water’ through a suitable outlet, that may be used for general purposes in the laboratory where water purity is not of concern.

The one or more first water purification process units may also include a filter to remove particles, and/or activated carbon for the removal of chlorine or chloramines from the feed water that would damage process equipment such as reverse osmosis or capacitive deionisation membranes.

The one or more first water purification process units may further include ion exchange resin in the sodium form to soften the feed water, by removing calcium ions that may precipitate in downstream purification processes.

The one or more second water purification process units may include a deioniser to purify the second internal purified water to a higher or third purified water quality. Unlike any deioniser in the first water purification station, a deioniser in the second water purification station may be required to remove dissolved carbon dioxide from the water. Preferably a deioniser in the second water purification station is a cartridge of ion exchange resin or an electrodeionisation unit. Operation of these units are known in the art and not described in detail herein.

Additionally, the one or more second water purification process units may further include one or more units for processes for oxidation of the water passing therethrough, either for inactivation of micro-organisms or for oxidation of organic molecules or both.

One common oxidiser involves the use of ultraviolet light, and the ultraviolet treatment of water for decomposing organic compounds or substances in water is well known in the art. Generally, ultraviolet light is able to decompose many organic compounds and substances that are contained or are residues in water, by oxidising them to form ionic or ionisable species that may be removed by the deioniser. Apparatus and instruments for providing suitable ultraviolet light are well known in the art, and may include one or more LEDs and typically involve emitting ultraviolet light at one or more specific wavelengths in an area or space in which the water is held or through which the water passes.

Alternatively or additionally, the oxidiser is a chemical oxidising species, such as a peroxide or ozone, which may be added or electrically generated or generated electrochemically, optionally in the relevant water from oxygen dissolved within it. Such oxidising species act on organic molecules to break them down, and where the organic molecules are associated with viable species, render the species non-viable.

Alternatively or additionally, the oxidiser involves ultrasonics, which may be used either to directly break down the bonds in organic molecules, or to create oxidising species that then cause such breakages.

Additionally, the one or more second water purification process units may further include a size exclusion filter such as an ultrafilter or microfilter, or a charged filter.

Embodiments of the present invention will now be described by way of example only and with reference to the accompanying drawings in which:

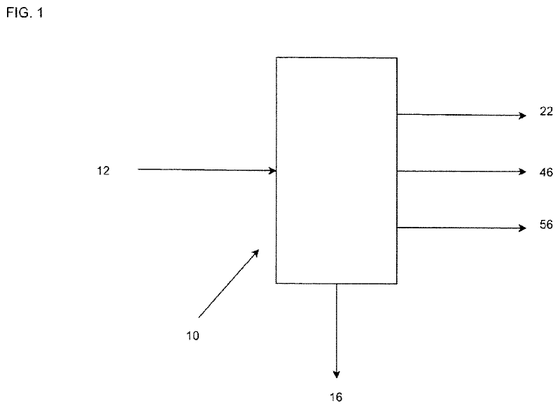

FIG. 1 is a simplified schematic view of a water purification apparatus and method that provides three dispense purified water streams of three different purities according to embodiments of the present invention;

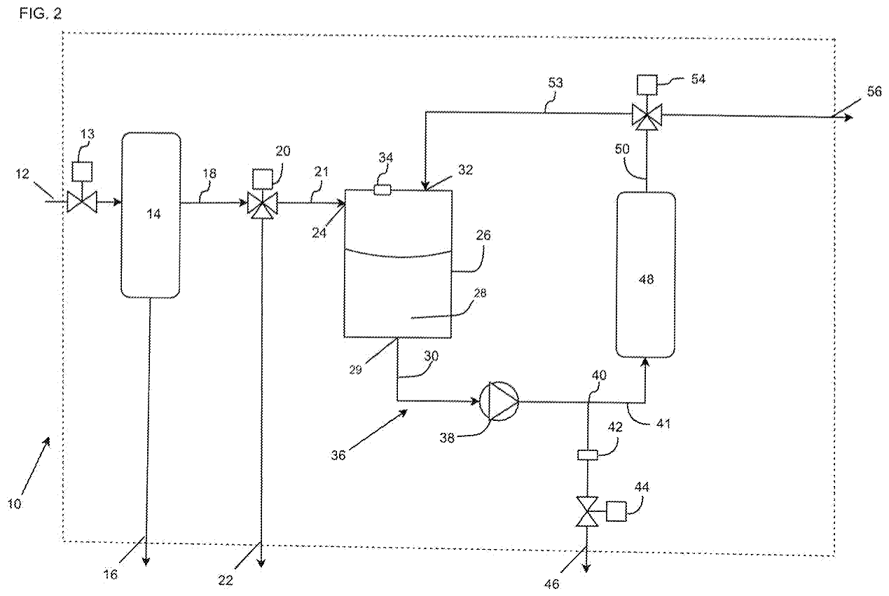

FIG. 2 is a schematic view of a first water purification apparatus and method according to a first embodiment of the present invention; and

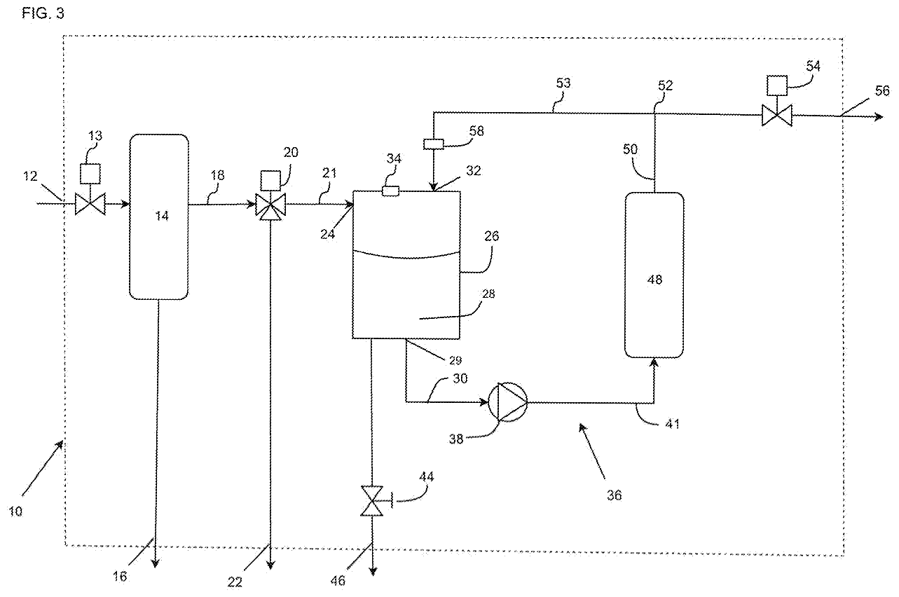

FIG. 3 is a schematic view of a second water purification system and method according to a second embodiment of the present invention; and

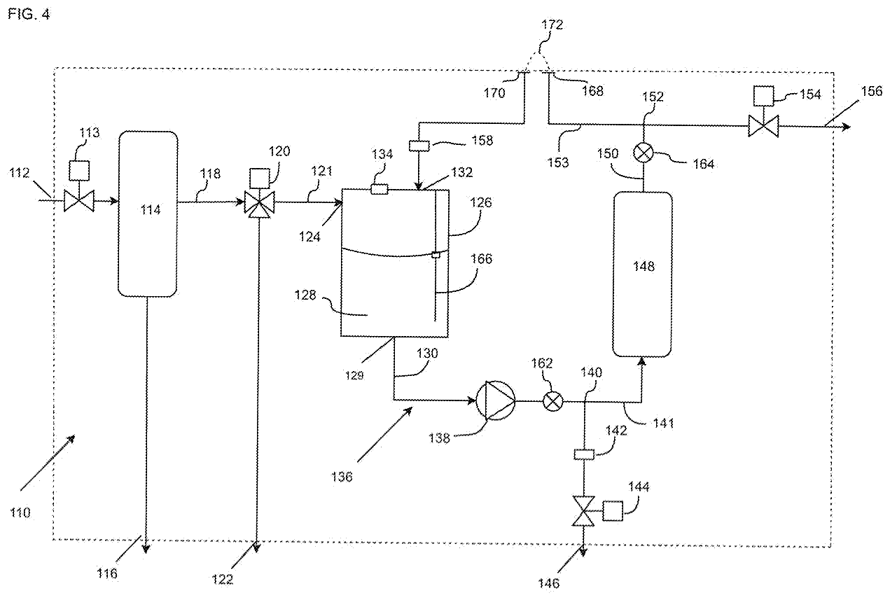

FIG. 4 is a schematic view of a third water purification system and method and means for monitoring the purity of each of the three different water purities according to a further embodiment of the present invention; and

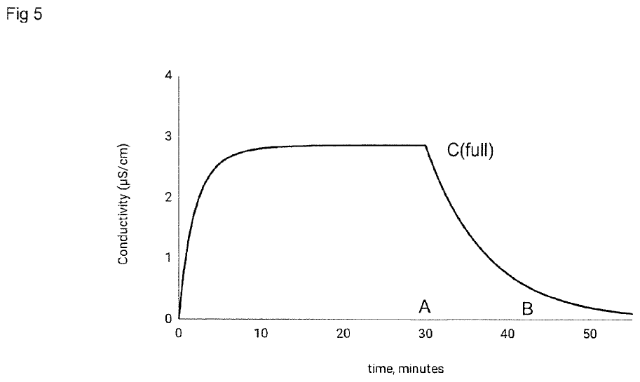

FIG. 5 is chart detailing conductivity as measured by a first conductivity cell used to indirectly determine the conductivity of a first internal purified water stream involved in the present invention.

Referring to the drawings, FIG. 1 shows a water purification apparatus that provides three outlet purified water streams of three different purities.

FIG. 1 is a simplified schematic diagram of one embodiment of the present invention, based on a water purification apparatus 10 having an inlet for connection to a supply of potable or similar water from within a laboratory, for a suitable water inlet stream 12, and three or four dispense outlets, one for each of a first dispense purified water stream 22, a second dispense purified water stream 46, a third dispense purified water stream 56, and an optional grey water outlet stream 16.

FIG. 2 shows a schematic diagram of a first embodiment of the water purification apparatus 10, the outside of which is shown by the dashed lines. Connections to a laboratory water supply, and for the passage of water within the water purification apparatus 10, are made by pipe or tube as known in the art.

The pipe for the water inlet stream 12 is connected to an inlet electrically activated valve 13, such as a solenoid valve, to control the flow of water into the apparatus 10. The outlet from the inlet solenoid valve 13 is connected to the first water purification station 14, able to purify the water inlet stream 12 to create a first purified water, which exits the first water purification station 14 as a first internal purified water stream 18.

The first water purification station 14 contains one or more deionising technologies, such as reverse osmosis or capacitive deionisation, to achieve the purification, and a grey water outlet stream 16 to discharge the ions removed by the deionising technologies and to provide a water stream that may be used for general purposes in the laboratory where water purity is not of concern.

The first water purification station 14 may also contain other technologies able to filter the inlet water stream 12, to remove particles prior to the deionising technology.

The first water purification station 14 may further contain technologies such as activated carbon, to remove chlorine or chloramines from the inlet water stream 12 prior to the deionising technology.

The first water purification station 14 may further contain technologies such as ion exchange resin to soften the inlet water stream 12 by exchanging divalent ions for sodium ions after the deionising technology.

The skilled man can see that the first water purification station 14 may include one or more water purification process units able to provide one or more of the above technologies, and generally known in the art.

The first internal purified water stream 18 is passed to a first valve 20, preferably an electrically actuated valve such as a solenoid valve, for selectively passing the first internal purified water stream, 18 to either a first purified water outlet as a first dispense purified water stream 22 from the water purification apparatus 10, or to an internal reservoir 26 as a first continuing water stream 21.

The internal reservoir 26 can be any suitable shape and design and volume. Optionally, the internal reservoir has a volume in the range of 3 to 10 litres, and has a first inlet 24 for the first continuing water stream 21. The internal reservoir 26 may also have an outlet 29 for water to exit into a recirculation loop 36, and a second inlet 32 for the returning recirculated water as described hereinafter.

The internal reservoir 26 contains a second purified water 28, being a mixture of first continuing water stream 21 that has entered by first purified water inlet 24, and water that has entered by the second water inlet 32 which is more purified than the first continuing water stream 21 as described hereinafter.

The internal reservoir 26 also contains a composite vent filter 34 to allow air passage into and out of the reservoir 26, thus equilibrating the air pressure inside and outside the reservoir 26, while also preventing particles, bacteria or carbon dioxide from entering the reservoir 26.

The second purified water 28 is drawn from the internal reservoir 26 as a second internal purified water stream 30, and passed around the recirculation loop 36 by an in-line pump 38. A tee or tee-junction 40 in the recirculation loop 36, preferably located after the pump 38 (so that the second internal purified water stream 30 is under pressure or ‘pressurised’ relative to atmospheric pressure), allows the second internal purified water stream 30 to progress towards a second water purification station 48. Some of the second internal purified water stream 30 may also be passed via a flow limiter 42 and second valve 44, preferably an electrically operated valve, as a second dispense purified water stream, 46, from the water purification apparatus 10.

The flow limiter 42 ensures that only part of the second internal purified water stream 30 exiting the pump 38 can be output as the second dispense purified water stream, 46, and that a flow is maintained to the second water purification station 48 as a second continuing water stream 41.

The second water purification station 48 contains one or more deionising technologies, such as ion exchange resin or electrodeionisation, able to remove ions and dissolved carbon dioxide from the water therein, to create a third purified water, which exits the second water purification station 48 as a third internal purified water stream 50. The second water purification station 48 may have a waste stream (not shown), that can be return water containing ions removed from the second water purification station 48 to a point prior to the first water purification station 14, or passed from the unit through the grey water outlet stream 16.

The second water purification station 48 may further contain oxidative technologies such as UV oxidation or ozone or peroxide production to remove viable bacterial contamination from the water.

The second water purification station 48 may further contain oxidative technologies such as UV, ozone, peroxide, sonolysis or electrochemical oxidation to break down organic molecules from the water.

The second water purification station 48 may further contain molecular filtration by size exclusion, such as microfiltration or ultrafiltration or by charged filters, to remove bacteria, molecules and particulate contamination from the water.

The third internal purified water stream 50 exiting the second water purification station 48 is passed to a third valve 54, optionally an electrically activated valve such as a solenoid valve, from which it is either returned to the internal reservoir 26 through the second water inlet 32 as a recirculated water return stream 53, or some or all of the third internal purified water stream 50 may be passed from the water purification apparatus 10 as a third dispense purified water outlet stream 56.

FIG. 3 shows a second embodiment of a water purification apparatus of the present invention having a number of similar features to the embodiment shown in FIG. 2 (not discussed in detail), and therefore having some common notation with FIG. 2.

In FIG. 3, the second purified water 28 in the internal reservoir 26 may be taken directly from the reservoir 26 by the action of the second valve 44, which may be an electrically actuated valve or a hand operated valve. This may, depending on the valve aperture, allow a faster flow for the second dispense purified water stream 46, but the second dispense purified water stream 46 is not pressurised above that afforded by gravity.

In FIG. 3 the third internal purified water stream 50 exiting the second water purification station 48 is passed to a second tee or tee-junction 52, from which it is either returned to the reservoir 26 through the recirculated second water inlet 32 as recirculated water return stream 53, or some or all of the third internal purified water stream 50 may be passed from the water purification apparatus 10 as the third dispense purified water outlet stream 56 by the action of the third valve 54, optionally an electrically actuated valve. It is preferable for the third valve 54 to be highly adjustable, such as being a stepper motor valve. A suitable pressure sustaining device 58 on the return path recirculated water return stream 53 to the reservoir 26, can maintain an outlet pressure for the third dispense purified water stream 56.

FIG. 4 shows a third water purification apparatus that provides three outlet purified water streams of three different purities according to an embodiment of the present invention, and which also provides monitoring of the purity of each of the three different purities according to a further embodiment of the present invention.

The third water purification system 110 has the same or similar components and features of the first and second water purification apparatuses 10 in the previous figures, and so using some notation numbering of +100 to represent such components and features.

The third water purification apparatus 110 further includes (a) a first in line water quality measurement device 162 for measuring the conductivity of the second internal purified water stream 130 provided from the internal reservoir 126 and pump 138, and (b) a second in line water quality measurement device 164 for measuring the conductivity of the third internal purified water stream 150 provided from the second water purification station 148. The first and second water quality measurement devices 162, 164, may be conductivity cells as known in the art, preferably with cell constants of 0.02 or less.

The third water purification apparatus 110 further includes a level sensor 166 in the internal reservoir 126. The level sensor 166 provides a measurement of the amount of water in the reservoir 126.

The third water purification apparatus 110 further includes locations 168, 170 for connecting a remote dispenser, or for extending the recirculation loop 136 around a laboratory. If no remote dispenser or recirculation loop extension is required, then a link 172 is present.

The third water purification apparatus 110 further includes a control system, not shown, such as a printed circuit board including a microprocessor and input means. Readings from the first and second water quality measurement devices 162, 164 are processed by the microprocessor and water purity is output to a user by display means as known in the art.

When water is being recirculated around the recirculation loop 136, and the internal reservoir 126, is being filled with first continuing water stream 18, the microprocessor uses a known ‘lookup table’ and/or uses an algorithm to calculate the purity of the first continuing water stream 18.

FIG. 5 shows a curve of how the conductivity of water measured at the first water quality measurement conductivity device or cell 162 of the apparatus shown in FIG. 4, based on a volume in the recirculation loop 136 of 0.5 litres, and a recirculation flow rate of 1.0 l/min, will vary when 5 litres are taken from a 7 litre reservoir, and the reservoir is refilled back to 7 litres at a rate of 167 ml/min with a first purified water with a conductivity of 20 μS/cm.

At time=0 the internal reservoir 126 starts to fill and the conductivity of the second purified water in the internal reservoir 126 increases to a conductivity approaching a steady level. At time A at 30 minutes, the reservoir becomes full and a measurement of the conductivity “C(full)”, as measured at the first conductivity cell 162, is taken. The microprocessor can then compare conductivity C(full) to a lookup table or use an algorithm to determine the conductivity of the first continuing water stream 121 that has been fed into the reservoir 126.

For any particular equipment the volume of the reservoir and recirculation loop are fixed. The curve of conductivity approaches a steady level, presuming that the fill is for a long enough period. In the example described above, a fill of over 2.5 litres corresponding to 15 minutes is suitable.

Conductivity C(full) will be affected by changes in flow rate of the first purified water filling the reservoir or of the rate of flow of the recirculated water. Fill flow rate can be determined by monitoring the rate of change of level sensor 166. Variation in flow rate can then be added to the algorithm or adjustment made to the lookup table.

It is preferable to use a positive displacement pump 138 for the recirculation loop to provide a constant flow therein. Greater certainty of the flow can be achieved by the addition of a flow rate monitor in the recirculation loop and one may be desirable in the water purification system to provide a user with information regarding the amount of water he is dispensing.

An additional or alternative method for determining the conductivity of the first purified water is to measure the time taken to purify the second purified water to a known conductivity. An example in FIG. 5 is the time taken for the conductivity of the second purified water to reduce from C(full) to 0.5 μS/cm i.e. from t=A to t=B. Again, a lookup table or algorithm can be used to determine the conductivity of the first purified water.

1. A water purification apparatus able to provide at least three dispense purified water streams of different water purities from the water purification apparatus, comprising at least:
(i) a water inlet stream;
(ii) a first water purification station comprising one or more first water purification process units connected to the water inlet and able to provide a first internal purified water stream;
(iii) a first valve able to select from the first internal purified water stream either a first dispense purified water stream or a first continuing water stream or both;
(iv) an internal reservoir within the water purification apparatus adapted to receive the first continuing water stream through a water inlet, to hold a volume of second purified water, and to provide a second internal purified water stream,
(v) a second valve able to dispense a second dispense purified water stream from the water purification apparatus;
(vi) a second water purification station comprising one or more second water purification process units able to receive the second internal purified water as a second continuing water stream and able to provide a third internal purified water stream;
(vii) a third valve able to select from the third internal purified water stream either a third dispense purified water stream, or a third continuing water stream, or both;
(vii) a recirculation loop able to return the third continuing water stream into the internal reservoir; and
(ix) a pump able to pump the second internal purified water stream from the internal reservoir around the recirculation loop.

2. A water purification apparatus as claimed in claim 1 wherein the first and second water purification stations include at least a deioniser.

3. A water purification apparatus as claimed in claim 2 wherein the deioniser in the first water purification station is selected from a group comprising: a reverse osmosis unit, a capacitive deionisation unit.

4. A water purification apparatus as claimed in claim 2 wherein the deioniser in the second water purification station is selected from a group comprising of: ion exchange resin, electrodeionisation.

5. A water purification apparatus as claimed in claim 1 wherein the second water purification station includes an oxidiser.

6. A water purification apparatus as claimed in claim 5 wherein the oxidiser provides oxidation selected from a group comprising: UV oxidation, ozonation, electrochemical oxidation, ultrasonic oxidation.

7. A water purification apparatus as claimed in claim 1 wherein at least one of or each of the first, second and third dispense purified water outlet streams is pressurised or pumped.

8. A water purification apparatus as claimed in claim 1 wherein the third dispense purified water stream is of greater purity than the second dispense purified water stream.

9. A water purification apparatus as claimed in claim 1 wherein the third dispense purified water stream is ultra-pure water of resistivity >15 MΩ·cm.

10. A water purification apparatus as claimed in claim 1 wherein the second dispense purified water stream is of greater purity than the first dispense purified water stream.

11. A water purification apparatus as claimed in claim 1 wherein the second dispense purified water stream has a resistivity of >1 MΩ.cm.

12. A water purification apparatus as claimed in claim 1 wherein the first dispense purified water stream is of greater purity than the inlet water stream (12).

13. A water purification apparatus as claimed in claim 1 wherein the first dispense purified water stream has a resistivity of >0.05 MΩ·cm.

14. A water purification apparatus as claimed in claim 1 wherein the second dispense purified water stream is provided from the recirculation loop.

15. A water purification apparatus as claimed in claim 14 wherein the second valve is able to select from the second internal purified water stream either the second dispense purified water stream, or the second continuing water stream, or both said streams.

16. A water purification apparatus as claimed in claim 1 wherein the second dispense purified water stream is provided from the internal reservoir.

17. A water purification apparatus as claimed in claim 1 provided within a single housing containing the first and second water purification stations, the internal reservoir, a control system, and the pump.

18. A water purification apparatus as claimed in claim 17 further including one or more water connections able to extend the third dispense purified water stream or the recirculation loop beyond or outside the housing.

19. A water purification apparatus as claimed in claim 1 being a portable water purification apparatus.

20. A water purification apparatus as claimed in claim 1 having a mass of <22 kg when the reservoir is full of water, or a mass of <15 kg when the reservoir is empty of water.

21. A water purification apparatus as claimed in claim 1 further comprising a first water quality measurement device to measure the water quality of the second purified water in the internal reservoir, and a reservoir level sensor able to measure the volume of the second purified water in the internal reservoir.

22. A water purification apparatus as claimed in claim 21 further comprising means to calculate the water quality of the first internal purified stream from the measurements of the first water quality measurement device and the reservoir level sensor.

23. A water purification apparatus as claimed in claim 1 further comprising a grey water outlet stream from the first water purification station.

24. A method of providing at least three dispense purified water streams from a portable water purification apparatus comprising at least the steps of:
(a) passing a water inlet stream through a first water purification station comprising one or more first water purification process units to provide a first internal purified water stream that is of higher purity than the water inlet stream,
(b) providing by selecting from the first internal purified water stream, either a first dispense purified water stream, or a first continuing water stream, or both;
(c) passing the first continuing water stream to an internal reservoir within the water purification apparatus through a water inlet, the internal reservoir holding a volume of second purified water, and providing a second internal purified water stream from the reservoir,
(d) providing by selecting, either from the reservoir or from the second internal purified water stream, a second dispense purified water stream, or a second continuing water stream, or both;
(e) passing the second continuing water stream to a second water purification station comprising one or more second water purification process units, and providing a third internal purified water stream that is of higher purity than the second continuing water stream;
(f) providing by selecting from the third internal purified water stream, either a third dispense purified water stream, or a third continuing water stream, or both;
(g) recirculating any third continuing water stream into the internal reservoir around a recirculation loop;
(h) pumping the second internal purified water stream from the internal reservoir around the recirculation loop.

25. A method as in claim 24 further comprising calculating the purity of the purified first internal purified water stream by measuring the conductivity of the second internal purified water stream.

26. A method as in claim 24 further comprising varying the speed of the recirculation loop.
